(19) United States
(12) Patent Application Publication
(10) Pub. No.: US 2001/0000258 A1
(43) Pub. Date: Apr. 12, 2001

(54) Articles made from polypropylene, higher alpha-olefin copolymers

(75) Inventors: James John McAlpin, Houston, TX (US); Aspy Keki Mehta, Humble, TX (US); Jean Philippe Autran, Cincinnati, OH (US)

Correspondence Address: EXXONMOBIL CHEMICAL COMPANY, P.O. BOX 149, Baytown, TX, 77522-2149, US

(73) Assignee: Exxon Chemical Patents Inc., Wilmington, DE (US)

(21) Appl. No.: 09/732,014

(22) Filed: Dec. 8, 2000

Related U.S. Application Data
(63) Continuation of application No. 08/565,351, filed on Nov. 30, 1995, now abandoned.
Application No. 08/565,351 is a continuation-in-part of application No. 08/248,283, filed on May 24, 1994, now abandoned.

(51) Int. Cl. C08F 4/44

(52) U.S. Cl. 526/348.2; 526/348.4; 526/348.5; 526/127; 526/160

(57) ABSTRACT

A molded or extruded article made from a propylene, α-olefin copolymer, where the α-olefin has 5 or more carbon atoms (higher alpha-olefins (HAO)), where the copolymer is made with a metallocene catalyst system, provides substantially higher cold flow resistance and resiliency than when the propylene copolymer contains an α-olefin of 4 or less carbon atoms. Other properties such as ultimate tensile strength and impact strength are substantially higher as well. Such polymers can be used to advantage in extruded profiles and molded parts either alone or in a thermoplastic olefin (TPO). Parts made from the propylene HAO copolymers or compounds made from them show improved creep resistance than propylene ethylene copolymers.

1. This application is a continuation of U.S. application Ser. No. 08/565,351, filed Nov. 30, 1995, which is hereby expressly incorporated by reference as though set forth in full herein, which is a continuation-in-part of U.S. application Ser. No. 08/248,283, filed May 24, 1994.

### TECHNICAL FIELD

2. This invention relates generally to films, sheets, molded articles, extruded profiles, tubing or similar articles made from propylene a-olefin copolymers. The articles exhibit exceptional physical properties, including relatively low cold flow or creep. More specifically this invention relates to the use of certain propylene α-olefin copolymers (formed using a metallocene catalyst system) where the α-olefin is selected from α-olefins having 5 or more carbon atoms.

### BACKGROUND

3. Polyolefin polymers are well known articles of commerce. The uses of polyolefins are many and well known to those of skill in the art. Polyolefins have many useful physical properties. However, in many applications, polyolefins display unacceptable cold flow properties, that is, at room temperature or service temperature, they exhibit flow when subjected to low levels of stress for an extended period. Cold flow resistance is a property of importance in many polymer applications. Cold flow is defined as the non-recoverable deformation of a polymer article in response to a force or stress (well below the yield stress of the material), applied for an extended time at a selected temperature. Different polymers will exhibit different resistances to cold flow.

4. Polypropylene homopolymers and copolymers have come into wide use. Over 5 million tons ( 4 million metric tons) of polypropylene are manufactured each year in the United States alone. Polypropylene has a wide range of commercial uses, from packaging films and sheeting to molded food containers and fibrous constructions employed for example in diapers and hospital gowns.

5. There are several classes of polypropylene. One of these classes is statistical copolymers of propylene and another alpha-olefin (for purposes of this application, this classification includes ethylene), sometimes also known as random copolymers. In the past this class has tended to be represented largely by copolymers of propylene and ethylene, usually made using Ziegler-Natta catalysts. Copolymerization of higher alpha-olefins (HAO) (those alpha-olefins of 5 or greater carbon atoms) with propylene, using Ziegler-Natta catalysts has been problematic in the past due to the lower reactivity of these catalysts towards higher alpha-olefins. The Ziegler-Natta catalyzed propylene-ethylene copolymers have generally found use based on their substantially different properties when compared to polypropylene homopolymers. Broadly, the differences between Ziegler-Natta catalyzed homopolymers and propylene-ethylene copolymers are seen in such properties as lower melting point, greater flexibility, better clarity and slightly improved toughness for the copolymer.

6. EP 0 495 099 Al to Mitsui Petrochemical Industries suggests a method for polymerization of the propylene α-olefins utilizing metallocene-alumoxane catalyst systems. The document also suggests a propylene α-olefin copolymer where the propylene is present from 90-99 mole % and the α-olefin is present from 1-10 mole %. This document suggests that the propylene α-olefin copolymers would have a narrow molecular weight distribution (Mw/Mn), the copolymer would have a low melting point, and the copolymers have excellent softness. The document also suggests a straight line relationship between Tₘ and propylene content, however, no distinction is drawn to the melting point depression effect of different α-olefins.

7. EP 0 538 749 Al to Mitsubishi Petrochemical Co. suggests a propylene copolymer composition to produce a film having excellent low-temperature heat sealing, where the composition has 1 to 70 wt % of A and 30-99 wt % of B where:

8. A is a propylene ethylene or α-olefin copolymer where the α-olefin has 4-20 carbon atoms and a M_{w}/Mₙ of not more than 3.

9. B is a propylene ethylene or α-olefin copolymer where the α-olefin has 4-20 carbon atoms and a M_{w}/Mₙ of 3.5 to 10.

10. Copolymer A is polymerized by a metallocene catalyst system.

11. Copolymer B is polymerized by a Ziegler-type catalyst.

12. Substantially all examples utilize propylene-ethylene copolymers or propylene homopolymers.

13. EP 0 318 049 Al to Ausimont suggests crystalline copolymers of propylene with minor portions of ethylene and/or α-olefins. The copolymers are said to have very good mechanical properties. The copolymers are polymerized in the presence of metallocene compounds. The examples of this document show propylene-ethylene and propylene-1-butene copolymers.

14. Among the polymers that demonstrate acceptable cold flow resistance are polyvinyl chloride (PVC). The cold flow resistance of PVC enables it to be used in applications where the relatively poor cold flow of polyolefins is unacceptable.

15. Fresh meat wrap is an example of the deficiency of polyolefins when compared to PVC. PVC films are known and valued for their ability to “snap back” after deformation. This snap-back attribute is directly related to the film's ability to resist cold flow. In retail meat displays, such deformation is caused when the packaged meat is handled. Because of its “snap back”, meat wrapped in PVC film, even after handling, does not show the effects of such handling. Polyolefins have repeatedly been tried in film applications such as meat wrap with little commercial success, because when deformed by handling, a polyolefin's tendency to cold flow leaves unacceptable finger marks or other depressions or distortions of the film even after the packaged meat itself has recovered (or substantially resumed the shape it had before deformation). Polypropylene and polyethylene of the polyolefins especially exhibit this deficiency, due to their relatively poor cold flow.

16. However, even though PVC has many advantages in applications as discussed above as well as many others, PVC has several substantial drawbacks that have made its replacement by other plastics, such as polyolefins, a high priority in many of those applications. As a first example of a drawback, the density of PVC is substantially higher than most polyolefins. The density of most PVC is about 1.2 g/cc versus a density well below 1.0 g/cc for most polyolefins. This has a very practical effect, that a given unit of weight of PVC will yield substantially less product than a unit of polyolefin. A second drawback of PVC is that upon combustion, for example in waste or trash incineration, PVC will evolve hydrochloric acid. Still another drawback, especially for food and medical related PVC applications, is the extractibility of plasticizers such as phthalate esters used in flexible PVC.

17. Polypropylenes can be molded or extruded into many shapes. Conventional homopolypropylene and conventional copolymers of propylene and ethylene show creep or cold flow when subjected to a force or stress. Additionally, polypropylenes are often blended with other materials to modify their properties, for example to give them rubbery or more rubbery characteristics.

18. Certain classes of compounded polypropylenes have rubber like characteristics. However, the polypropylene compounds need no vulcanization.

19. Polyolefins such as polypropylene are not generally considered elastic, however, they are generally rigid and light weight. Rubbers on the other hand are elastic, but are not rigid.

20. Rubber products have generally found extensive use in applications which require elasticity and flexibility. Molding of rubber into a finished product entails a curing step, generally referred to as vulcanization, which requires the use of specialized molding machines, long cycle times and a number of complicated processing steps. The rubber molding process, therefore, does not lend itself easily to mass production due to these processing difficulties. It highly desirable to find a rubber or rubber like compound without the need for a vulcanization step.

21. Many attempts have been made to find such rubber analogs. For example, flexible plastics such as flexible vinyl chloride resins, ethylene/vinyl acetate copolymers and low density polyethylenes generally have good flexibility, fabrication and molding properties, but suffer from poor heat resistance, and resiliency (rebound) which greatly restrict their utility.

22. In order to improve the properties of such flexible plastics, they have been blended with high melting point plastics such as high density polyethylene and polypropylene. This blending, however, causes a loss in flexibility.

23. More recently, a class of compounds having properties between those of cured rubbers and soft plastics have been investigated. These compounds are generally referred to as thermoplastic elastomers (TPE). The classical TPE structure involves a matrix of an elastomer such as, for example, a polybutadiene, polyester or polyurethane, tied together by thermoplastic junction regions. A well known example of a TPE is Shell's Kraton® G, triblock of styrene and hydrogenated polybutadiene, where the thermoplastic crosslinking points are small domains of glassy polystyrene held together by rubbery polybutadiene blocks. This structure leads to behavior similar to vulcanized elastomers at ambient temperature but, at temperatures above the polystyrene softening point, the system undergoes plastic flow.

24. A subset of thermoplastic elastomers, embodying only olefin based polymers, is referred to as thermoplastic olefins (TPO). A typical TPO comprises a melt blend or like mixture of at least one thermoplastic polyolefin resin, with at least one olefin copolymer elastomer (OCE). The thermoplastic polyolefin resin will give the TPO rigidity and temperature resistance while the elastomer imparts flexibility and resilience as well as improving the toughness of the material.

25. TPOs find particular application in the auto industry for flexible exterior body parts such as, for example, bumper covers, nerf strips, air dams and the like. In such applications, it is desired that the TPO have good resiliency (ability of the part to return to its original shape after deformation), impact strength at low temperatures, flexibility, high heat distortion temperature, surface hardness and surface finish characteristics. Additionally ease of processability and molding is desired.

26. Other application for TPOs include films, footwear, sporting goods, electric parts, gaskets, water hoses and belts, to name just a few. Particularly in films, elasticity and clarity properties are important. Other of the aforementioned properties will be important depending upon the desired application.

27. However, TPOs suffer compared to TPEs such as Kraton G due to the inability of the polypropylene matrix to resist stress over relatively long periods of time.

28. Polymer compositions such as TPEs exhibit cold flow resistance and resiliency that generally exceeds that of TPOs. This cold flow resistance and resiliency enables TPEs to be used in applications where the relatively poor cold flow and resiliency of polyolefins such as polypropylene unacceptable. Such applications include molded articles for automobiles and appliances. In molded articles, shape is often a critical parameter. Cold flow due to a contained load or due to an applied force could cause unacceptable non-recoverable deformation in a molded part. Additionally, much less weight and time would be necessary to cause a load-set or deformation due to a static load if the molded parts are fabricated from most polyolefins rather than TPOs. Versus TPEs, the performance of most polyolefins would be even poorer.

29. Even though TPEs have many advantages as discussed above, their cost makes them unacceptable for some applications and marginally acceptable in others. While much less expensive than TPEs, TPOs on the other hand are not an ideal choice either due to the above mentioned defensive physical properties.

30. There is therefore a need for a polyolefin, specifically a polypropylene copolymer that will resist cold flow to a sufficient extent that it could replace conventional PPs or the polypropylene component in blends, eg TPOs, in many applications.

### SUMMARY OF THE INVENTION

31. It has been discovered that propylene copolymers made utilizing metallocene catalyst systems to polymerize propylene with α-olefin comonomers having 5 or more carbon atoms (higher alpha-olefins (HAO)), show a surprising enhancement in important physical properties when compared to propylene copolymers utilizing alpha-olefins of 4 carbon atoms or less (for purposes of this application, this classification includes ethylene). In an embodiment of the present invention, the most striking step change is evidenced in the present invention in cold flow resistance or creep resistance values on articles made from materials made according to this embodiment. These changes will be noted in articles made from the copolymer themselves, or in parts fabricated from a TPO containing these copolymers.

32. In an embodiment of the present invention, extruded, molded and calendared articles such as film, tubing, extruded profiles, molded parts, sheets, or other fabricated articles are comprised of an isotactic statistical copolymer of propylene and HAO and alternatively TPOs utilizing these copolymers. The HAO is present in the range of from about 0.2 to about 6 mole percent. The copolymer will have a molecular weight distribution (MWD) M_{w}/Mₙ (weight average molecular weight/number average molecular weight) ≦5 and a peak melting point (DSC) in the range of from about 100° C. to about 145° C. An article made from these copolymers will exhibit improved creep or cold flow resistance when compared to a propylene ethylene copolymer of similar flexability.

### BRIEF DESCRIPTION OF THE DRAWINGS

33. These and other features, aspects, and advantages of the present invention will become better understood with regard to the following description, appended claims and accompanying drawings where:

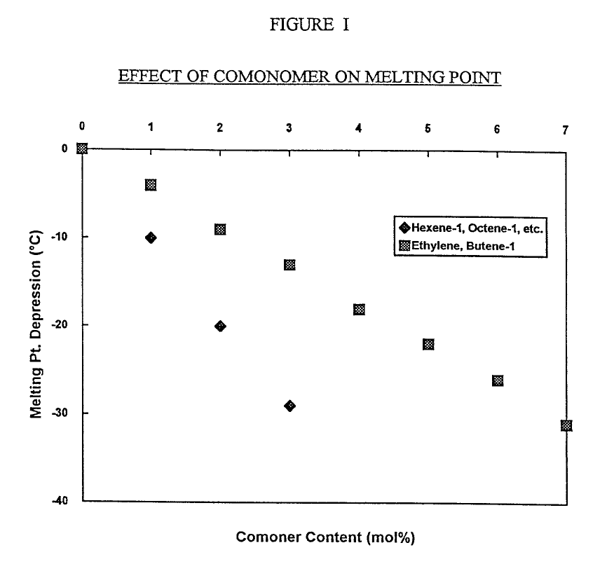

34. FIG. 1 shows the effect of comonomer on melting point depression in a propylene copolymer.

### DESCRIPTION OF THE PREFERRED EMBODIMENTS

35. The present invention concerns certain classes of fabricated polypropylene articles, and their uses. These articles have unique characteristics which make them well suited for use in certain applications. Flexible films, tubing, sheets, extruded profiles, molded articles and other articles made therefrom have superior cold flow resistance compared to extruded profiles and molded parts made from polypropylene-ethylene copolymers. A detailed description follows of certain preferred resins for use in fabricating articles that are within the scope of our invention, and preferred methods of producing these resins and their products.

36. Those skilled in the art will appreciate that numerous modifications to these preferred embodiments can be made without departing from the scope of the invention. For example, though the properties of films and molded plaques are used to exemplify the attributes of the copolymers of the present invention, the copolymers have numerous other uses. To the extent that our description is specific, this is solely for the purpose of illustrating preferred embodiments of our invention and should not be taken as limiting our invention to these specific embodiments.

37. The term random or statistical copolymer as used herein shall mean copolymers of propylene and other α-olefins polymerized in a medium which the contents of the various comonomers and other process conditions are maintained substantially constant throughout the course of the reaction. Variations in the composition of the resulting copolymers due to the existence of chemically distinct sites within the catalytic entity from which they are prepared or to normal variations experienced in sequenced reactors, as long as the resulting “reactor blend” polymers are miscible in the melt, are accepted in the current definition.

38. We have discovered that certain metallocene catalyst systems can be used to polymerize propylene statistical copolymers having properties which are highly desirable for conversion into various products. Generally these resins are isotactic polypropylene statistical copolymers, the copolymers utilize propylene and one or more alpha-olefins. For purposes of this application, the term isotactic is intended to mean a polymer where propylene tacticity distribution will be greater than about 90 percent mmmm pentads, where m is a meso diad, (m is defined as the same relative configuration of methyl groups of two successive monomer units (diad) to each other), preferably in the range of from about 94 to about 98 percent mmmm pentads, most preferably in the range of from about 95 to about 97 percent mmmm pentads, as determined by nuclear magnetic resonance (NMR).

### Production of the Resins

39. The polypropylene copolymers of the present invention are preferably produced using supported metallocene catalysts. The copolymers may be produced in fluidized bed or stirred bed gas phase reactors, slurry or bulk liquid reactors of tank or loop type, or other processes practiced for the polymerization of polypropylene. Series bulk liquid boiling pool reactors are preferred.

40. Specific metallocene-type catalysts known to be useful for producing isotactic olefin polymers may be found in, for examples, EPA 485 820, EPA 485 821, EPA 485 822 and EPA 485 823, by Winter, et al. and U.S. Pat. No. 5,017,867 by Welborn. These publications are incorporated in the present application by document for purposes of U.S. patent practice.

41. Various publications describe placing catalyst systems on a supporting medium and use of the resulting supported catalysts. These include U.S. Pat. Nos. 5,006,500, 4,925,821, 4,937,217, 4,953,397, 5,086,025, 4,912,075, and 4,937,301 by Chang and U.S. Pat. Nos. 4,808,561, 4,897,455, 5,077,255, 5,124,418, and 4,701,432 by Welborn, all of which are incorporated in the present application by reference for purposes of U.S. patent practice.

42. Specific information on the use of support techniques for metallocene-type catalysts, for use in the preparation of propylene alpha-olefin polymers may be found in U.S. Pat. No. 5,240,894 by Burkhardt, also incorporated by reference for purposes of U.S. patent prosecution. While catalysts used for the following examples are employed in a bulk liquid-phase polymerization, catalysts for commercial use may be used in other processes including for example, gas phase and slurry process.

43. Resins produced by the above referenced processes and catalysts can have alpha-olefin comonomers in the range of from about 0.2 mole percent to about 6 mole percent. Above 6 mole percent, the resulting resin may make an extruded profile, or molded article with a melting point or softening point too low for most preferred applications. Below 0.2 mole percent comonomer, the flexural modulus may become too high, leading to a product that may be too stiff for most of applications. In a more preferred embodiment, the alpha-olefin comonomer is present in the range of from about 0.4 to about 3.5 mole percent. In a most preferred embodiment the alpha-olefin is present in the range of from about 0.5 to about 3 mole percent. In the most preferred embodiment, the alpha-olefin is present in the range of from about 1 to about 3 mole percent.

44. In one preferred embodiment, the catalyst system comprises a silicon bridged bis (substituted 2-methyl-indenyl) zirconium dichloride or a derivative thereof, methyl alumoxane and an inorganic support. In a more preferred embodiment dimethyl silyl bis (2-methyl-benzindenyl) zirconium dichloride is the metallocene of choice. This preferred catalyst system is used to generate the propylene-ethylene and propylene-hexene resins used in the films whose properties are shown in Table 1. However, it would be possible to copolymerize any alpha-olefin of 2 to 20 carbon atoms utilizing these and similar catalyst systems.

45. Further details regarding preparation of the catalyst system and production of the resin are provided in the examples that follow.

### Characteristics of the Resins

46. The polymers of the present invention are substantially isotactic in nature. The polymers will generally have a narrow molecular weight distribution, as characterized by the M_{w}/Mₙ, (weight average molecular weight/number average molecular weight) (molecular weight distribution MWD), of ≦5. Preferably ≦3.5, more preferably ≦3.2, most preferably ≦3.0 and the most preferred ≦2.5. M_{w}/Mₙ (MWD) is determined by Gel Permeation Chromatography (GPC), as is molecular weight. Such techniques are well known. The techniques are described in copending application U.S. Ser. No. 08/164,520 incorporated herein by reference for purposes of U.S. patent practice. The polymers will exhibit melting points in the range of from about 100° C. to about 145° C., more preferably in the range of from about 110° C. to about 135° C., most preferably in the range of from about 115° C. to about 135° C.

47. Food law compliance can be an important criterion for articles made from these resins, such compliance usually directly affected by the extractable content of an article made from a resin. A standard of U.S. Food and Drug Administration as noted in 21 CFR § 177.1520 is to use the n-hexane reflux procedure, the maximum extractables level of the products of the present invention is expected to be less that about 5 wt %, preferably less than about 4 wt %, most preferably less than about 3 wt %.

48. Useful melt flow rates of the polymers of the present invention are in the range of from about 0.1 to about 5000 dg/min. In a preferred embodiment, the melt flows are in the range of from about 0.5 to about 200 dg/min. In a most preferred embodiment, the melt flow rates are in the range of from about 1 to about 100 dg/min. Melt flow rates are measured by ASTM D-1238 condition L.

### Making a Film, Tubing, or Sheet

49. Films may be made by any techniques known by those of ordinary skill in the art. For example, blown films produced with an annular die and air cooling, or cast films using a slot die and a chill-roll for cooling are both acceptable techniques. Oriented films may be produced by either post extruder manipulation of the blown film through heating and orientation, or by longitudinal stretching of an extruded sheet followed by tentering techniques. Films are generally in the range of from about 0.2 to about 10 mils (5.08 to 254 μm).

50. Sheet may be made either by extruding a substantially flat profile from a die, onto a chill roll, or alternatively by calendaring. Sheet will generally be considered to have a thickness of from 10 mils to about 100 mils (254 μm to 2540 μm), although sheet may be substantially thicker. Films or sheets for test purposes may be made by compression molding techniques, as well.

51. Tubing may be obtained by profile extrusion. For use in medical applications or the like, the tubing will generally be in the range of from about 0.31 cm (⅛″) to about 2.54 cm (1″) in outside diameter, and have a wall thickness of in the range of from about 254 μm (10 mils) to 0.5 cm (200 mils).

52. Films made from the products of a version of the present invention may be used to contain food articles such as meat and snacks for instance. Such films may also be used to protect and display articles of apparel.

53. Sheet made from the products of an embodiment of a version of the present invention may be used to form containers. Such containers may be formed by thermoforming, solid phase pressure forming, stamping and other shaping techniques may be used for foods such as meat or dairy products. Sheets may also be formed to cover floors or walls or other surfaces.

54. Tubing made from the products of this invention may be used in medical, food, or other uses that will be apparent to those of ordinary skill in the art.

### Molded Articles and Extruded Profiles

55. Molded articles may be made by any techniques known to those of ordinary skill in the art. For example, molded articles may be fabricated by injection molding, blow molding, extrusion blow molding, rotational molding, and foam molding. Molded parts are found in many thicknesses of 500 μm (20 mils) or greater. For molded articles, the thickness of a cross section of the article will generally be in the range of from about 508 μm to about 2.5 cm.

56. Molded articles for health care devices, such as, for example, syringes are also contemplated.

57. Table I sets forth the physical property data for a propylene-ethylene copolymer film and a propylene-hexene copolymer film meeting the description of this application. The film test is used as an indicator of molded article or extruded profile performance.

58. The data in Table I show that other physical/mechanical properties of articles fabricated from the resins of the present invention will also show an improvement in value, as noted before, when compared to propylene copolymers of lower alpha-olefins. It can be readily seen that the data in Table I showing that the films prepared from the hexene-1 copolymer have relatively high resistance to cold flow (creep) as indicated by their Rₘₐ values (Rₘₐ defined below). Films formed from propylene-ethylene copolymers, on the other hand display the expected relatively poor resistance to cold flow. The differences discussed above between the tested propylene hexene-1 and propylene-ethylene copolymers (both metallocene catalyzed), can also be expected with propylene copolymers of other HAOs, when compared with propylene-ethylene copolymers.

### Properties of Molded Articles and Extruded Profiles Produced From the Resins

59. The resins discussed above, when formed into molded articles, will show superior properties when compared to either commercially available, Ziegler-Natta catalyzed or metallocene catalyzed propylene α-olefin resins where the α-olefin has 4 carbon atoms or less.

60. Prospective examples 5-8 indicate that molded parts will show improved physical properties in the comparison noted above.

### Determination of Rₘₐ

61. A parameter useful for characterizing cold flow resistance or creep resistance, is a value known as time delayed compliance (TDC). For purposes of this application, TDC is defined as the amount of strain observed in an article that is placed under a specific stress for a specified time divided by the magnitude of the stress. The time specified should be chosen such that the time delayed compliance at that time is at least two (2) times the initial compliance of the material. Those of ordinary skill in the art will recognize that the stress should be below the specimen's yield stress.

62. A useful technique for evaluating the step change in properties between propylene-HAO copolymers and propylene-ethylene copolymers has been developed (both metallocene catalyzed).

63. For films, molded articles, tubing, sheets, and similar articles and other articles made from them, the technique uses the ratio of the TDC of a propylene-ethylene copolymer, to the TDC of a propylene-HAO copolymer.

64. The ratio is represented by the symbol Rₘₐ where:

$${R}_{ma} = \frac{TDC \text{(of propylene-ethylene copolymer article)}}{TDC \text{(of propylene-HAO article)}}$$

65. where the resins to form each article are chosen such that the tensile modulus of each article is substantially the same as that of the other article.

66. In the determination of Rₘₐ, it is important that substantially all parameters that affect the physical properties of the articles in both the numerator and denominator of the ratio be the same.

67. Such parameters include, but are not limited to:

68. for the resins: molecular weights should vary by no more than 10%

69. for the fabricated article: fabrication conditions and techniques;

70. dimensions of the test specimen;

71. post fabrication treatments;

72. blend components; or additives

73. It will be understood by those of ordinary skill in the art that comonomer content (either HAO or ethylene) can be varied for purposes of attaining substantially the same tensile modulus in both the propylene-HAO and propylene-ethylene copolymers.

74. The choice of equal tensile modulii for the articles of both numerator and denominator ensures that the comparison is made at a constant degree of flexibility of the articles. Articles made from isotactic propylene-HAO copolymers of the present invention will have a Rₘₐ exceeding about 1.1, indicating significantly improved resistance to cold flow compared to isotactic propylene-ethylene copolymers. Blends of olefin polymers, wherein at least one polymer is a statistical isotactic propylene-HAO copolymer are also contemplated as long as the Rₘₐ of the article is greater than about 1.1. Possible blend materials may include, but are not limited to; ethylene copolymers of ethylenically unsaturated esters, polyethylene homopolymers and copolymers with α-olefins, polypropylene homo and copolymers, ethylene propylene rubbers (EP), ethylene, propylene, diene monomer elastomers (EPDM), styrene-butadiene-styrene (SBS), additives such as slip agents, anti-static agents, colorants, anti-oxidants, stabilizers, fillers, and reinforcers such as CaCO₃, talc, and glass fiber, and other additives that will be well known to those of ordinary skill in the art.

75. An Rₘₐ of at least 1.1 indicates that an article will exhibit significantly better cold flow resistance than an article made from a propylene-ethylene copolymer. The greater the Rₘₐ number, the more improved the compliance of the propylene-HAO copolymer in relation to the propylene-ethylene based article. In a preferred embodiment, the Rₘₐ is at least 1.2. In a more preferred embodiment, the Rₘₐ is at least 1.3.

76. In addition to better cold flow resistance, these propylene-HAO copolymers exhibit other improved physical properties. Table I compares physical properties of propylene copolymers of ethylene and propylene copolymers of HAOs and demonstrates that ultimate tensile strength, and impact strength of the propylene-HAO copolymers for example, are significantly improved.

77. A further indication of the fact that the class of propylene-HAO copolymers is distinct from the propylene-ethylene or propylene-butene copolymer class, is found in the response of the melting points of the copolymers to co-monomer incorporation. This is illustrated in FIG. 1 It can be seen that the melting point depression for a given molar comonomer incorporation is about twice as much for the propylene-HAO copolymers as for the ethylene and butene resin class of propylene copolymers.

78. Blends of olefins polymers including the statistical propylene HAO copolymers of the present invention and other materials such as additives or other polyolefins are also contemplated.

### EXAMPLE 1

### Preparation Of Metallocene Catalyst

79. A silica supported metallocene catalyst is prepared according to the teachings of U.S. Ser. No. 07/885,170 using dimethyl silyl, bis(2 methyl, 4,5 benzindenyl) zirconium dichloride as the metallocene. The catalyst recipe is 400 grams of silica (Davison 948), 10 grams of metallocene and 3 liters of 10 wt % methyl alumoxane (MAO) in toluene solution as described in OrganoMetallics, v. 13, No. 3, 1994, p. 954-963. Approximately 600 grams of the finished catalyst system is recovered. This catalyst is prepolymerized with one weight of ethylene per weight of catalyst system at a temperature of about 15° C. The ethylene is added over a period of 1.5 hours to assure slow reaction rate.

### EXAMPLE 2

### Preparation Of Propylene-Ethylene Copolymers

80. Approximately 15 grams of ethylene and 550 grams of propylene are added to an autoclave maintained at 30° C. After allowing time for equilibration, 0.2 grams of the prepolymerized catalyst of example 1 is added to the reactor and the temperature raised to 50° C. over a period of several minutes. An immediate reaction is observed. The reaction is terminated after 30 minutes to limit the extent of conversion of the ethylene so that its concentration in the reaction medium nearly constant over the period of the reaction. A total of 114 grams of propylene-ethylene statistical copolymer is obtained. Its weight average molecular weight as measured by size exclusion chromatography is 184,000, its ethylene content (measured by FTIR) is 3.3 wt %, and its peak melting point is 121° C.

### EXAMPLE 3

### Preparation Of Propylene-Hexene Copolymers

81. To the autoclave of Example 2 is added 550 grams of propylene and 34 grams of hexene-1. The catalyst of Example 1 is added (0.2 grams) and the temperature controlled as in Example 2. The reaction is allowed to run for a total of two hours in this case since the relative reactivities of propylene and hexene-1 are nearly the same under these conditions. A total of 222 grams of propylene-hexene statistical copolymer is obtained. Its weight average molecular weight as measured by size exclusion chromatography is 204,000, its hexene-1 content is 2.9 wt % (measured by FTIR), and its peak melting point is 126° C.

### EXAMPLE 4

### Preparation Of Propylene 1-Octene Copolymers (Prospective Example)

82. To the autoclave of Example 2, 550 grams of propylene is added along with approximately 45 grams of 1-octene as the molar amount of Example 3. The catalyst of Example 1 is added and the temperature is controlled as in Example 2. The reaction is allowed to run for 2-3 hours as the reactivities of propylene and 1-octene is nearly the same under these conditions. Over 200 grams of propylene-octene statistical copolymers could be expected. The average molecular weight as measured by size exclusion chromatography is over 200,000. The octene-1 content is expected to be between 2.0 and 4 wt % (if measured by FTIR), and its peak melting point is in the range of 125-135° C.

### EXAMPLES 5 and 6

### Film Preparation and Testing

83. These examples show preparation of films from the copolymers of examples 2 and 3 including details of procedures for film forming and property measurement. The data is summarized in Table 1. (Film preparation and testing from a resin produced in Example 4 would follow the same procedures.)

84. A film of the copolymer to be characterized is formed by compression molding 9.2 grams of the granular copolymer between Mylar® sheets in a form 15×15 centimeters in area and 0.5 mm in thickness. The molding procedure is: 1) close the platens (controlled at a temperature of 200° C.) until they contact the sample; hold for one minute with no applied pressure; 2) increase the clamping force to 10 Tons and hold for one minute; 3) increase the clamping force to 40 tons and hold for two minutes; 4) release the clamping force and quench the film (still between the Mylar sheets) in a water bath at room temperature. After the films are conditioned for six days at room temperature, dumbbell samples are die-cut from the films.

85. The tensile properties of the resulting samples are measured on a Zwick REL 2051 tensile tester at a temperature of 25±2 degrees C for the standard tensile properties, procedure DIN 53457 (1987) is adhered to. For the measurement of time delayed compliance, the tensile specimen is loaded into the tester just as if one are doing the standard tensile test. A predetermined load is applied and the specimen elongation is recorded as a function of time. The load is chosen to be in the range of 50-60% of that which would cause the specimens to experience yielding (for samples presented here, a load of 11.7 MPa is chosen). The sample elongation recorded 480 seconds after the load is initially applied is chosen as a measure of cold flow for the particular load and this strain divided by the stress applied is designated “the time-delayed compliance”.

86. The results of the evaluation are shown in Table 1.

### Determination of Rₘₐ

87. The tensile properties of parts made from the resins of examples 2-4 are measured on a tensile tester at a temperature of 25±2 degrees C for the standard tensile properties. For the measurement of time delayed compliance, the tensile specimen is loaded into the tester just as if one are doing the standard tensile test. A predetermined load is applied and the specimen elongation is recorded as a function of time. The same load is chosen for both parts to be tested, per the definition of Rₘₐ, where the two parts have substantially the same modulus. The sample elongation recorded 480 seconds after the load is initially applied is chosen as a measure of cold flow for the particular load and this strain divided by the stress applied is designated “the time-delayed compliance”.

### EXAMPLE 7 (PROSPECTIVE EXAMPLE)

### Molded Article Preparation and Testing

88. The following prospective examples outline expected improvements in molded part performance of the propylene copolymer or TPOs formulated using this copolymer of the present invention compared to either propylene polymers made with conventional Ziegler-Natta catalysts or compared to propylene copolymers of propylene and an alpha-olefin of 4 or less carbon atoms that are produced by metallocene catalyst systems and TPOs formulated using these latter copolymers.

89. Mechanical properties are evaluated by the following tests:

90. (1) Melt Flow Rate—ASTM D-1238, Condition L.

91. (2) Flexural Modulus, secant—ASTM D-790.

92. (3) Shore D Hardness—ASTM D-2240.

93. (4) Notched Izod—ASTM D-256.

94. (5) Tensile Properties—ASTM D-638.

95. (6) Brittleness Temperature—ASTM D-746.

96. (7) Vicat Softening Temperature—ASTM D-1525.

97. (8) Shrinkage—ASTM D-995.

98. (9) Density—ASTM D-2240.

99. (10) Bending Beam Resiliency—a 5 in.×0.5 in.×0.125 in. specimen, held by a ½ in. mandrel, is bent at an angle of 90° and held for 3 seconds. After release, the specimen is allowed 2 minutes of unstressed recovery. The angle from the normal is then measured and reported as resiliency. 0° would constitute complete recovery and “perfect” resiliency.

100. A sample is injection molded in an Van Dorn injection molding press into standard parts for the various ASTM tests, then tested for selected mechanical properties.

101. Although the present invention has been described in considerable detail with references to certain preferred versions thereof, other versions are possible. Therefore, the spirit and scope of the appended claims should not be limited to the description of the preferred versions contained therein.

TABLE I

| | Copolymer of | Copolymer of |
|---|---|---|
| Polymer | Example 2 | Example 3 |
| Tensile Modulus (MPa) | 583 | 604 |
| TDC (11.8 Mpa load; time 480 sec) | 5.3 | 3.15 |
| Rₘₐ | 1.0 | 1.68 |
| Tensile Strength (Ultimate - MPa) | 38.0 | 43.7 |
| Dart Impact Strength (Nm/mm) | 12.5 | 14.0 |
| DSC Peak Melting Point ° C. | 121 | 126 |

We claim:

1. An article comprised of an isotactic copolymer of propylene and at least one α-olefin having 5 or more carbon atoms;
said α-olefin being present in the said copolymer in the range of from about 0.2 to about 6 mole percent based on the total moles of monomer in said copolymer, said copolymer having a M_{w}/Mₙ≦5, said copolymer having a peak melting point in the range of from about 100° C. to about 145° C.; and
wherein an article made from said copolymer has an Rₘₐ of at least about 1.1.

2. An article as recited in claim 1 wherein said article further comprises a second polyolefin, wherein said second polyolefin is selected from the group consisting of polyethylene, polypropylene and olefinic elastomers.

3. An article as recited in claim 1 wherein said (α-olefin is selected from the group consisting of 1-pentene, 4-methyl-1-pentene, 1-hexene and 1-octene.

4. An article as recited in claim 1 wherein said propylene copolymer is produced using a metallocene catalyst system.

5. An article as recited in claim 4 wherein said metallocene catalyst system contains a silicon bridged bis (substituted 2-methyl-indenyl) zirconium dichloride and methylalumoxane activator.

6. An article as recited in claim 1 wherein said copolymer further comprises an additional comonomer, selected from the group of a-olefins consisting of from 2 to 20 carbon atoms.

7. The article of claim 1 wherein said article is selected from the group consisting of a film, a molded part, tubing, and sheet.

8. The article of claim 1 wherein said Rₘₐ exceeds about 1.2.

9. An article as recited in claim 1 wherein said Rₘₐ exceeds about 1.3.

10. An article as recited in claim 1 wherein said α-olefin is present in the range of from about 0.5 to about 3 mole percent.

11. An article as recited in claim 1 wherein said copolymer has an M_{w}/Mₙ<3.5.

12. An article comprising at least a first isotactic propylene α-olefin copolymer, said α-olefin being selected from the group consisting of 1-pentene, 4-methyl-1-pentene, 1-hexene and 1-octene;
said propylene α-olefin copolymer being polymerized by a metallocene-alumoxane catalyst system, wherein said metallocene is dimethyl silyl bis (2-methyl-benzindenyl) zirconium dichloride;
wherein said α-olefin is present in the range of from about 1 to about 3 mole percent based on the total moles of said propylene α-olefin copolymer;
said copolymer has a M_{w}/Mₙ≦3; and
said copolymer has a melting point in the range of from about 115° C. to about 135° C.

13. An article comprising an isotactic copolymer of propylene, a first α-olefin and a second comonomer;
said first α-olefin selected from the group consisting of 1-pentene, 4 methyl-1-pentene, 1-hexene and 1-octene;
said second comonomer selected from the group consisting of ethylene, 1-butene, 4-methyl 1-pentene, 1-hexene and 1-octene;
wherein said first α-olefin and said second comonomer are present in said copolymer in a combined total of said first α-olefin and said second comonomer in the range of from about 0.5 to about 3 mole percent, based on the total moles of monomers in said copolymer;
wherein said copolymer has a M_{w}/Mₙ≦3;
wherein a film made from said copolymer has an extractable level less than about 3 weight percent; and
said film having an Rₘₐ of at least 1.2.

14. An article comprising a propylene α-olefin copolymer, said α-olefin being selected from the group consisting of 1-pentene, 1-hexene and 1-octene;
said propylene α-olefin copolymer being made utilizing a metallocene catalyst system, wherein said metallocene is dimethyl silyl bis (2-methyl-benzindenyl) zirconium dichloride;
wherein said α-olefin is present in the range of from about 1 to about 2 mole percent;
said copolymer has a M_{w}/Mₙ≦3;
said copolymer has a melting point in the range of from about 115° C. to about 135° C.;
wherein said copolymer is substantially isotactic;
wherein a molded article made from said propylene (α-olefin copolymer has an extractable level less than about 3 weight percent; and
wherein said molded article has an Rₘₐ exceeding about 1.3.

15. The article of claim 14 wherein said article is selected from the group consisting of, a food container, a medical device, a syringe, and a vehicle part.
